(19) United States
(12) Patent Application Publication
(10) Pub. No.: US 2006/0238001 A1
(43) Pub. Date: Oct. 26, 2006

(54) Chassis and/or supporting structure of a motor vehicle

(75) Inventors: Martin Konermann, Stuttgart (DE); Alexander Moessner, Leonberg (DE); Volker Schwarz, Ebersbach (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 10/534,132

(22) PCT Filed: Oct. 13, 2003
(86) PCT No.: PCT/EP03/11299

§ 371 Date: Apr. 18, 2006

(30) Foreign Application Priority Data
Nov. 8, 2002 (DE) 102 51 945.5

(51) Int. Cl. B60J 7/00

(52) U.S. Cl. 296/205

(57) ABSTRACT

A chassis and/or supporting structure of a motor vehicle, in particular of a passenger vehicle, is entirely or partially designed as a hollow chamber sheet structure.

### BACKGROUND AND SUMMARY OF THE INVENTION

This invention relates to a chassis and/or a supporting structure of a motor vehicle such as a passenger vehicle.

Chassis are usual subassemblies for ensuring structural strength in conventional vehicles and are accordingly widely used. They have a plurality of longitudinal members and cross members which are generally manufactured from sectional steel and are connected to one another by fastening means, such as, for example, screws or spot welds. In motor vehicles, chassis are used primarily for accommodating the driving device, axles and vehicle body.

Depending on the construction of the chassis, use is sometimes also made of hollow profiles which are generally, however, of closed design in order to protect against corrosion. The chassis type is used on account of the higher moment of resistance of hollow profiles relative to mass in comparison with solid profiles.

German document DE 40 07 771 A1 discloses a device for preventing spray from escaping in the wheel region of motor vehicles, in particular of trucks. In this case, provision is made, either between a longitudinal member of the vehicle chassis and the vehicle chassis or between a wing and the vehicle chassis, to lay, along the longitudinal members, a suction line which, in accordance with the Venturi principle, generates a suction effect and reduces the escaping of spray. Although German document DE 40 07 771 A1 mentions a separately laid suction line, nothing more is disclosed.

The present invention is concerned with the problem of specifying an alternative construction for a chassis and/or a supporting structure.

This problem is solved by the subject matter of the present invention. Advantageous embodiments are the subject matter of the dependent claims.

The invention is based on the general concept of designing a chassis and/or a supporting structure of a motor vehicle as a hollow chamber sheet structure. In contrast to a conventional vehicle body shell having very few cavities (for example, sills), the hollow chamber sheet structure provides a duct system over a relatively large area. As a result, new possibilities arise for allowing the air mass flows, which because of a specific function (for example cooling air, ventilation of the passenger cell) are passed through a vehicle, to be discharged in a quite specific manner at certain locations on the vehicle. This makes it possible for circulation around the vehicle to be positively influenced by, for example, some of the exhaust air from the engine compartment conducted through a hollow chamber base to the rear of the vehicle where it influences or reduces the axle pin rake of the vehicle in such a manner that the air resistance and the lifting effect of the vehicle are reduced. In vehicles with a solid rear, dirtying of the rear window is reduced.

The clearance through the flow ducts, which are present in the hollow chamber sheet structure and are intended for ventilating and venting the passenger cell, is substantially larger, and it is probable that separately constructed flow ducts, which are still necessary currently, can be eliminated, as a result of which the production costs are reduced. In addition, a largely free design and arrangement of the ventilation and venting of the passenger cell enables a reduction of door-closing forces to be achieved by means of a more rapid dissipation of pressure in the passenger cell.

Provision can expediently be made to design the hollow chamber sheets as light metal elements and/or as plastic elements. Light metals and plastics are materials which are generally of low weight and arc easy to machine. Light materials, particularly in the construction of vehicles, are of substantial importance with regard to the preservation of resources which is becoming ever more important. A low overall weight permits the use of a lower powered driving device for the same ride comfort and therefore permits a reduction in the consumption of gasoline.

There is still significant development potential in the sphere of plastics and composite materials, such as, for example, glass fiber or carbon fiber reinforced plastics. The performance of fiber reinforced plastics is known, for example, from racing (monocoque).

According to a particularly favorable embodiment of the invention, the hollow chamber sheets may be designed as extruded profiles and/or as built-up profiles, in particular of sheet metal. Extruded profiles can be produced in a simple and cost-effective manner nowadays and permit an individual reworking of an otherwise identical extruded profile basic body. As a result, it is possible to produce different vehicle chassis for different types of vehicle merely by means of a corresponding reworking of extruded profile sheets which are identical in the basic state, thus achieving a substantial simplification of production.

By contrast, built-up hollow chamber profiles afford the advantage of enabling vehicle chassis to be manufactured with a highly individual orientation. Particularly in high-price vehicles, customers frequently require individual modifications of the vehicle chassis. In the case of built-up profiles, these modifications may already be taken into consideration in the construction state and therefore prevent a complicated reworking of a standard profile.

In one particularly advantageous embodiment of the invention, the flow ducts are of controllable design by means of flaps at an inlet and outlet opening. A specific control of the passage of air through the flow ducts affords the advantage of influencing such properties of the vehicle as, for example, the contact pressure of the vehicle on the underlying surface. For example, the flaps may be activated in such a manner that a greater air throughput is made possible at higher speeds than at a low speed. The flow ducts running in the vehicle chassis, the flaps attached to the outflow openings of the flow ducts, and the shape of the inflow and outflow openings bring about effects similar to those of a spoiler, as a result of which a lifting effect of the vehicle is reduced. The flow through the ducts can be assisted by the use of fans.

Further important features and advantages of the invention will be apparent from the dependent claims, from the drawings, and from the associated descriptions of the figures with reference to the drawings.

The features mentioned above and those which have yet to be explained below can be used not only in the described combination, but also in other combinations or on their own without departing from the scope of the present invention.

Preferred exemplary embodiments of the invention are illustrated in the drawings and are explained in greater detail in the descriptions below, with identical reference numbers referring to identical or similar or functionally identical components.

### BRIEF DESCRIPTION OF THE DRAWINGS

FIG. 1 shows an oblique view of a vehicle chassis according to the invention,

FIG. 2 shows a cross section through a hollow chamber profile according to the invention, and

FIG. 3 shows a possible course of flow ducts through the vehicle chassis.

### DETAILED DESCRIPTION OF THE INVENTION

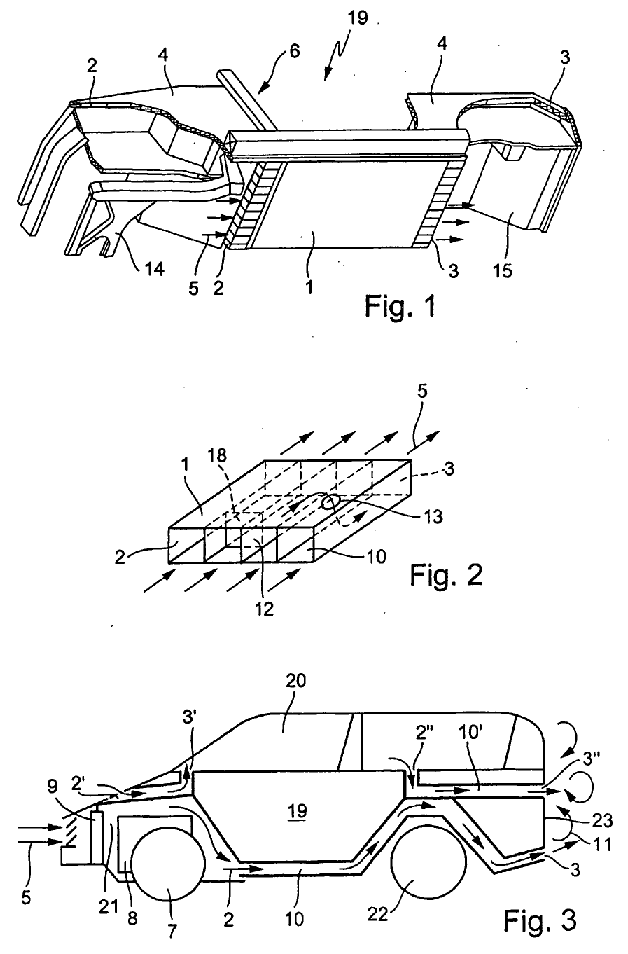

A chassis 6 and/or a supporting structure of a motor vehicle 19 (otherwise not illustrated) is designed in accordance with FIG. 1. The chassis 6 has a plurality of sheet-like individual elements, such as, for example, a hollow chamber bottom sheet 1 (also referred to below in simplified form as hollow chamber sheet 1), vertical hollow chamber sheets 4, and hollow chamber sheets 15 connecting the vertical hollow chamber sheets 4. The hollow chamber sheets 1, 4 and 15 together with a base frame 14 form the supporting structure of the motor vehicle 19. The individual hollow chamber sheets 1, 4, 15 are connected to one another in a suitable manner, for example by welding and/or bonding, and stiffen the chassis 6.

FIG. 2 illustrates a detail from the hollow chamber sheet 15 by way of example. It should expressly be mentioned that the detail in FIG. 2 can also be transferred to the other hollow chamber sheets 1, 4 listed.

The hollow chamber sheet 15 is constructed from a top sheet 16 and a bottom sheet 17 which is connected by partition walls 12 running orthogonally with respect to the two planes of the sheets between the top sheet 16 and the bottom sheet 17. The partition walls 12 result in the production of flow ducts 10 which are in each case separated from one another, run parallel and have an essentially rectangular cross section. In this case, the number of partition walls 12 determines the number and the cross section of the individual flow ducts 10.

As illustrated in FIG. 2, an air flow 5 enters through an inflow opening 2 on one side of the hollow chamber sheet 15 into the flow duct 10 and exits again through an outflow opening 3 on the other side. In this case, it is conceivable to use individual flow ducts 10 for the air flow 5 while other flow ducts 10 remain unused. In addition, a deflection of the air flow 5 out of the plane of the hollow chamber sheet 15 through an opening 13 is also possible in order to pass the air flow, for example, into a vertically adjoining hollow chamber sheet 4.

In this case, the arrangement of the opening 13 is not restricted to the top or the bottom sheet. The opening may also be integrated into the partition walls 12, as a result of which a connection is provided between the individual flow ducts 10. By means of the arrangement of one or more openings 13 in one or more partition walls 12 in conjunction with a blocking wall 18, which is placed upstream or downstream in the direction of flow and closes the cross section of the flow duct 12, it is possible to influence the cross section available for the air flow 5, and therefore the flow velocity.

It is thus conceivable for the air flow 5 to enter through an individual inflow opening 2 into the flow duct 10 and to be distributed there on account of at least one opening 13 provided in the partition wall 12 to at least two flow ducts 10, and therefore to emerge again from the hollow chamber sheet 15 through a plurality of outflow openings 3. The effect which can therefore be achieved by changing the flow cross section during the flow operation is that an air flow 5 which is rapid at the inflow opening 2 has a substantially lower velocity when it exits from the hollow chamber sheet 15 through a plurality of outflow openings 3.

The reverse case, and therefore an increase in the flow velocity, is also possible, i.e. entry of the air flow 5 through a plurality of inflow openings 2 and a combining of a plurality of flow ducts 10 by means of openings 13 integrated into the partition walls 12 to form just one flow duct 10 with one outflow opening 3. This effect is reinforced by the blocking walls 18, which are orthogonal to the direction of flow, close the cross section of the flow duct 10 and are arranged downstream of the opening 13 in the direction of flow.

One possible course of the flow ducts 10 through the motor vehicle 19 is implemented in accordance with FIG. 3. Inflow openings 2 are provided in the region of a front part of the motor vehicle 19 and in the region of the hollow chamber bottom sheet 1.

The air flow 5 occurring counter to a customary direction of travel, after entry into the engine compartment 21, impinges against the radiator 9, flows around the driving device 8 and, after a front vehicle wheel 7, passes in the direction of travel through an inflow opening 2, which is arranged in the hollow chamber bottom sheet 1, into the flow duct 10 and is guided on the bottom side under a passenger cell 20 in the direction of a rear vehicle wheel 22. In this case, the flow duct 10 is arranged along a wheel house in the region of the rear vehicle wheel 22 and, after the rear vehicle wheel 22 in the direction of travel, is guided level with a bumper (not illustrated) to the rear 23 of the vehicle.

It is also conceivable in this connection for the flow duct 10 in the region of the rear vehicle wheel 22 to have an inflow opening 2 after the rear vehicle wheel 22 in the direction of travel, as a result of which spray in the wheel house that may occur during the wet is sucked out and transported to the rear 23 of the vehicle 19. At the rear 23 of the vehicle, the air flow 5 flowing in the flow duct 10 passes through the outflow opening 3 into the surroundings.

A further flow duct begins with an inflow opening 2′ below an engine hood 24 of the motor vehicle 19 and has an outflow opening 3′, through which the air flow 5 passes into the passenger cell 20. In the rear region of the passenger cell 20, as seen in the direction of travel, there is arranged at least one further inflow opening 2″ to a further flow duct 10′ which connects the passenger cell 20 to the rear 23 of the vehicle. This further flow duct 10′ has a further outflow opening 3″ at the rear 23 of the vehicle. This ensures a continuous and predeterminable ventilation and venting of the passenger cell 20.

By means of the predetermined arrangement of the outflow openings 3 and 3″ at the rear 23 of the vehicle, a reduction in the dirtying of the rear 23 of the vehicle and also a reduction in the lifting effect of the motor vehicle 19 can be achieved. At the same time, the air vortices 11 resulting from a process of circulating air around the motor vehicle 19 are reduced, which reduces the fuel consumption.

In summary, the construction according to the invention can be characterized as follows.

The supporting structure comprising hollow chamber sheets 1, 4, 15 results in the provision of an extensive system of flow ducts 10, as a result of which the air flows 5 are conducted in a specific manner through or around the vehicle 19. The air resistance and the lifting effect of the vehicle are reduced and the dirtying of the rear 23 of the vehicle is reduced.

Furthermore, separate ventilation ducts which are still currently constructed can partially be managed without, thus reducing the production costs. In addition, an improvement in the ventilation and venting of the passenger cell 20 and a reduction in the door-closing forces by means of a more rapid dissipation of pressure in the passenger cell 20 are achieved.

In this case, the hollow chamber sheets 1, 4, 15 may also be designed as light metal elements and/or as plastic elements, as a result of which a reduction in the consumption of gasoline is achieved.

Certain properties of the vehicle 19, such as, for example, the contact pressure of the vehicle 19 on the underlying surface, are influenced by flaps (not illustrated in FIG. 2) at the inflow and outflow openings 2, 3 of the flow ducts 10. The flaps attached to the outflow openings 3 and 3″ of the flow ducts 10, and the shape of the outflow openings 3 and 3″ cause spoiler effects.

1-13. (canceled)

14. A chassis, a supporting structure, or a chassis and a supporting structure of a motor vehicle designed as a hollow chamber sheet structure.

15. The chassis, the supporting structure, or the chassis and the supporting structure of a motor vehicle as claimed in claim 14, wherein when the motor vehicle has two or more axles, a bottom hollow chamber sheet arranged between the axles is adjoined in the region of the axles by vertical, flanking hollow chamber sheets, and wherein the vertical sheets are stiffened, are connected to one another, or are both stiffened and connected to one another in the transverse direction of the vehicle by further hollow chamber sheets, struts, or both further hollow chamber sheets and struts.

16. The chassis, the supporting structure, or the chassis and the supporting structure of a motor vehicle as claimed in claim 14, wherein flow ducts are formed, between at least one inflow opening on a front part of the vehicle and at least one outflow opening at a rear of the vehicle, within the chassis, the supporting structure, or the chassis and the supporting structure.

17. The chassis, the supporting structure, or the chassis and the supporting structure of a motor vehicle as claimed in claim 16, wherein the at least one outflow opening at the rear of the vehicle is arranged and designed in such a manner that dirtying of the rear of the vehicle is reduced.

18. The chassis, the supporting structure, or the chassis and the supporting structure of a motor vehicle as claimed in claim 16, wherein the at least one outflow opening at the rear of the vehicle is arranged and designed in such a manner that air vortices at the rear of the vehicle are reduced.

19. The chassis, the supporting structure, or the chassis and the supporting structure of a motor vehicle as claimed in claim 16, wherein a passenger cell is ventilated and vented by at least some of the flow ducts.

20. The chassis, the supporting structure, or the chassis and the supporting structure of a motor vehicle as claimed in claim 14, wherein the hollow chamber sheet structure has hollow chamber sheets which are designed as light metal elements.

21. The chassis, the supporting structure, or the chassis and the supporting structure of a motor vehicle as claimed in claim 14, wherein the hollow chamber sheet structure has hollow chamber sheets which are designed as plastic elements.

22. The chassis, the supporting structure, or the chassis and the supporting structure of a motor vehicle as claimed in claim 14, wherein the hollow chamber sheet structure has hollow chamber sheets which are designed as extruded profiles.

23. The chassis, the supporting structure, or the chassis and the supporting structure of a motor vehicle as claimed in claim 14, wherein the hollow chamber sheet structure has hollow chamber sheets which are designed as built-up sheet metal profiles.

24. The chassis, the supporting structure, or the chassis and the supporting structure of a motor vehicle as claimed in claim 16, wherein a lifting effect of the vehicle is reduced by the flow ducts, the at least one inflow opening and the at least one outflow opening, or both the flow ducts and the at least one inflow opening and the at least one outflow opening.

25. The chassis, the supporting structure, or the chassis and the supporting structure of a motor vehicle as claimed in claim 16, wherein a downforce of the vehicle is achieved by the flow ducts, the at least one inflow opening and the at least one outflow opening, or both the flow ducts and the at least one inflow opening and the at least one outflow opening.

26. The chassis, the supporting structure, or the chassis and the supporting structure of a motor vehicle as claimed in claim 16, wherein the flow ducts are of controllable design by way of flaps at the at least one inflow opening and the at least one outflow opening.

27. The chassis, the supporting structure, or the chassis and the supporting structure of a motor vehicle as claimed in claim 14, wherein the motor vehicle is a passenger vehicle.

28. The chassis, the supporting structure, or the chassis and the supporting structure of a motor vehicle as claimed in claim 15, wherein flow ducts are formed, between at least one inflow opening on a front part of the vehicle and at least one outflow opening at a rear of the vehicle, within the chassis, the supporting structure, or the chassis and the supporting structure.

29. The chassis, the supporting structure, or the chassis and the supporting structure of a motor vehicle as claimed in claim 15, wherein the hollow chamber sheet structure has hollow chamber sheets which are designed as plastic elements.

30. The chassis, the supporting structure, or the chassis and the supporting structure of a motor vehicle as claimed in claim 15, wherein the hollow chamber sheet structure has hollow chamber sheets which are designed as extruded profiles.

31. The chassis, the supporting structure, or the chassis and the supporting structure of a motor vehicle as claimed in claim 15, wherein the hollow chamber sheet structure has hollow chamber sheets which are designed as built-up sheet metal profiles.

32. The chassis, the supporting structure, or the chassis and the supporting structure of a motor vehicle as claimed in claim 16, wherein the hollow chamber sheet structure has hollow chamber sheets which are designed as extruded profiles.

33. The chassis, the supporting structure, or the chassis and the supporting structure of a motor vehicle as claimed in claim 16, wherein the hollow chamber sheet structure has hollow chamber sheets which are designed as built-up sheet metal profiles.
